(19) United States
(12) Patent Application Publication
(10) Pub. No.: US 2014/0325583 A1
(43) Pub. Date: Oct. 30, 2014

(54) VIDEO TRANSMITTER APPARATUS AND VIDEO RECEIVER APPARATUS, AND VIDEO TRANSMITTING METHOD AND VIDEO RECEIVING METHOD

(71) Applicants: Masaki Mukawa, Hitachi (JP); Keisuke Inata, Tokyo (JP); Nobuaki Kabuto, Tokyo (JP)

(72) Inventors: Masaki Mukawa, Hitachi (JP); Keisuke Inata, Tokyo (JP); Nobuaki Kabuto, Tokyo (JP)

(21) Appl. No.: 14/359,941

(22) PCT Filed: Nov. 25, 2011
(86) PCT No.: PCT/JP2011/006556

§ 371 Date: Jun. 16, 2014

(51) Int. Cl. H04N 21/238; H04N 21/438

(52) U.S. Cl. CPC H04N 21/238; H04N 21/438
USPC 725/116; 725/134

(57) ABSTRACT

A video transmitter apparatus for transmitting video information to a video receiver apparatus, comprises: a compressor portion for compressing the video signal; and a transmitter portion for transmitting the video information compressed in the compressor portion, wherein the compressor portion and the transmitter portion are controlled, upon basis of a condition of displaying the video information on the video receiver apparatus. And, a video receiver apparatus for receiving video information, which is transmitted from a video transmitter apparatus, comprises: a receiver portion for receiving the video signal; a processor portion for processing the video information, which is received by the receiver portion; and a display portion for displaying the video information, which is processed in the processor portion, wherein a display condition of the video information on the display portion is transmitted to the video transmitter apparatus.

### TECHNICAL FIELD

The present invention relates to a transmitting/receiving of video information.

### BACKGROUND OF THE INVENTION

In such technical field as mentioned above, in the following Patent Document 1 is described, for achieving an object of dissolving the problem(s), “for enabling preferable transmission of a video signal of a desired bit rate, within a transmission bit rate of a transmission path” (see [0009] of the Patent Document 1), there is described an apparatus “comprising a video signal output portion for outputting non-compression video signal to be transmitted, a compression method information obtaining portion for obtaining information indicative of compression methods, with which a receiver apparatus is able to deal, from said receiver apparatus through a transmission path, a video signal compressor portion for treating a compression process of the compression method corresponding to that indicated by the compression method information, which is obtained in said compression method information obtaining portion, upon the non-compression video signal, which is outputted from said video signal output portion, and thereby outputting a compression video signal, a video signal selector portion for selecting the non-compression video signal, which is outputted from said video signal output portion, or the compression video signal, which is outputted from said video signal compressor portion, a video signal transmitter portion for transmitting the video signal, which is selected in said video signal selector portion, through a transmission path of a wire or radio-wave, a transmission controller portion for controlling operations of said video signal compressor portion and said video signal selector portion, and a compression information supply portion for supplying control information of said video signal compressor portion and said video signal selector portion by said transmission controller portion, through said transmission path t said receiver apparatus” ([0010] of the Patent Document 1).

Also, in the following Patent Document 2 is described, for achieving an object of dissolving the problem(s), “for providing a video processing method and a video processing apparatus of lowering the electric power consumption therein” (see [0007] of the Patent Document 2), there is described “a video processing method for transmitting digital video data fitting to a continuous transmission clock from a first video processor portion to a second video processor portion, wherein said digital video data is compressed within said first video processor portion, while expanding said digital video data compressed within said second video processor portion, and whereby transmitting the digital video data, intermittently, during a period having no necessity of transmitting the digital video data, which is generated through the compression of said digital video data in said first video processor portion” (claims of the Patent Document 2).

### PRIOR ART DOCUMENTS

### Patent Documents

[Patent Document 1] Japanese Patent Laying-Open No. 2009-213110; and

[Patent Document 2] Japanese Patent Laying-Open No. 2010-130391.

### BRIEF SUMMARY OF THE INVENTION

### Problem(s) to be Dissolved by the Invention

However, any one of the prior art documents fails to consider transmission of the video information for reducing deterioration of picture quality, which a user can feel.

### Means for Dissolving the Problem(s)

For dissolving such problem(s) as mentioned above, the structures as described in claims, for example, are adopted.

Though the present application includes therein a plural number of means; however, if listing up one example, there is provided a video transmitter apparatus for transmitting video information to a video receiver apparatus, having a compressor portion for compressing the video information, a transmitter portion for transmitting the video information compressed in the compressor portion, wherein the compressor portion and the transmitter portion are controlled upon basis of a display condition of the video information on the video receiving apparatus.

With such means as was mentioned above, it is possible to achieve transmission of the video information with reducing the deterioration of the picture quality thereof, which the user can feel.

### BRIEF DESCRIPTION OF THE SEVERAL VIEWS OF THE DRAWING

FIG. 1 is a view for showing the configuration of a video transmitter apparatus;

FIG. 2 is a view for showing the configuration of a video receiver apparatus;

FIG. 3 is a view for showing a display condition of an entire picture on a video display apparatus;

FIG. 4 is a view for showing a display condition of a thumbnail picture on the video display apparatus;

FIG. 5 is a view for showing a display condition of a thumbnail picture on the video display apparatus;

FIG. 6 is a view for showing a display condition where the thumbnail picture is hidden on the video display apparatus;

FIG. 7 is a view of an example of presenting a multi-channel display condition on VendorSpecificDataBlock in E-EDID;

FIG. 8 is a view for showing a display condition of an entire picture on a video display apparatus;

FIG. 9 is a view for showing a display condition of a thumbnail picture on the video display apparatus;

FIG. 10 is a view for showing a display condition of the thumbnail picture on the video display apparatus; and

FIG. 11 is a view of an example of presenting a multi-channel display condition on VendorSpecificDataBlock in E-EDID.

### MODE FOR CARRYING OUT THE INVENTION

### Embodiment 1

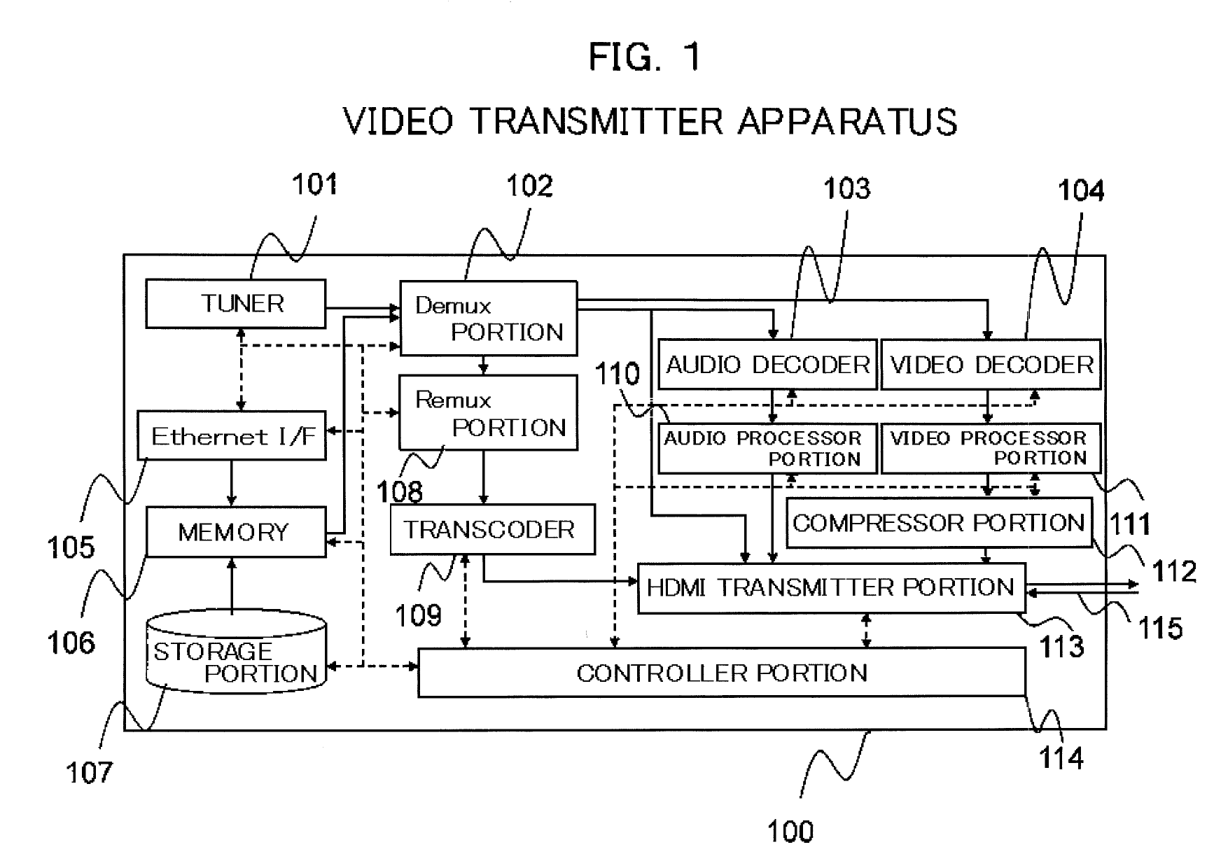

FIG. 1 is a view for showing a display condition of an entire picture on a video display apparatus, according to the present embodiment. A reference numeral 100 depicts a video transmitter apparatus, 101 a tuner, 102 a Demux portion, 103 an audio decoder portion, 105 an Ethernet I/F portion, 106 a memory, 107 a storage portion, 108 a Remux portion, 109 a transcoder, 110 an audio processor portion, 111 a video processor portion, 112 a compressor portion, 113 a HDMI transmitter portion, 114 a controller portion, and 115 a transmission path from HDMI transmitter portion to a HDMI receiver, respectively.

The tuner 101 receives a broadcast signal and conducts modulation upon a digital signal compressed. The Demux portion 102 divides the digital signal inputted from the tuner 101 or the memory 106 into a video signal and an audio signal. The audio decoder portion 103 and the video decoder portion 104 decode the video and the audio, which are divided in the Demux portion 102, i.e., decoding the video and the audio data into a original signal. Also, the Ethernet I/F portion 105 receives the video and the audio from external equipment through the Ethernet. However, the “Ethernet” is a registered trademark.

The memory 106 is a memory for storing the data received from the Ethernet I/F 105, or the video and the audio data, which are read out from the storage portion 107. The Remux portion 108 restructures the video signal and the audio signal, which are divided in the Demux portion 102, in the form of stream data. The transcoder 109 has a function of compressing the video inputted, again, and thereby changing the compression ratio thereof. The audio processor portion 110 conducts controls, such as, outputting the audio signal, which is inputted from the audio decoder, fitting to (or in synchronism with) the video signal. The video processor portion 111 has a function of scaling the video signal, which is inputted from the video decoder, into an arbitrary size thereof, and also a function of converting a YCbCr4:4:4 format into a YCbCr4:2:2 format or a YCbCr4:2:0 format, relating to a color difference signal, etc.

The compressor portion 112 compresses the video signal, which is inputted from the video processor portion 111.

The HDMI transmitter portion 113 converts the video and the audio signals, which are inputted from the compressor portion 112 and the video processor portion 111, into a HDMI signal, and thereby to transmit them. It also is able to transmit the stream signal, which is inputted from the transcoder 109, and the audio signal under the compression condition before decoding from the Demux portion 102. The controller portion 114 controls each portion from the tuner 101 to the HDMI transmitter portion 113 mentioned above. However, in the present embodiment, although the video signal inputted from the compressor portion 112 is outputted from the HDMI transmitter portion 113; however, without conducting the compression in the compressor portion 112, it is also possible to output the non-compression video signal from the HDMI transmitter portion 113.

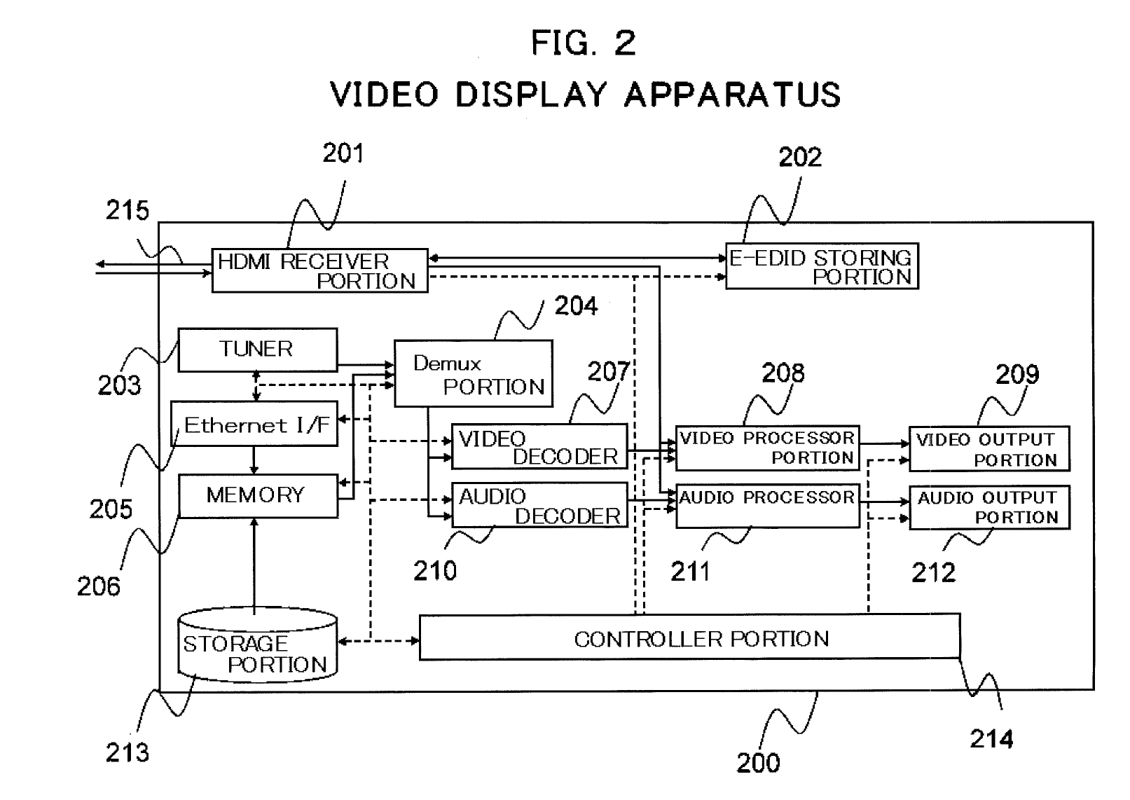

FIG. 2 is a view for showing the structure of the video receiver apparatus according to the present embodiment. A reference numeral 200 depicts a video receiver apparatus, 201 a HDMI receiver portion, 202 an E-EDID storing portion, 203 a tuner, 204 a Demux portion, 205 an Ethernet I/F portion, 206 a memory, 207 a video decoder, 208 a video processor portion, 209 a video output portion, 210 an audio decoder, 211 an audio processor, 212 an audio output portion, 213 is a storage portion, 214 a controller portion for controlling those from the HDMI portion 201 to the storage portion 213 mentioned above, respectively. A reference numeral 215 depicts a transmission path for transmitting the signal(s) from a HDMI transmitter portion to a HDMI receiver.

The HDMI receiver potion 201 receives a HDMI signal from the video transmitter apparatus, and thereby outputting it to the video processor portion 208 and the audio processor portion 211. Herein, by reading out data from the E-EDID storing portion 202, it is possible to notice a result of reading out of E-EDID data through a DDC line, to the HDMI signal receiver as E-EDID information of the video receiving equipment side.

The tuner 203 receives and demodulates the broadcast signal, and thereby obtaining a digital signal compressed. The Demux portion 204 divides the digital signal, which is inputted from the tuner 203 or the memory 206, into a video signal and an audio signal. The audio decoder 210 and the video decoder 207 conduct decoding of the video and the audio, which are divided in the Demux portion 204. Also, the Ethernet I/F 205 receives the video and the audio from the external equipment through an Ethernet circuit network. However, the “Ethernet” is the registered trademark.

The memory 206 is a memory for storing the data, which is received from the Ethernet I/F 205, or the video and the audio data, which are read out from the storage portion 213. The audio processor portion 210 conducts such a control or the like therein, that the audio signal inputted from the audio decoder, or the audio signal inputted from the HDMI receiver portion 201, is outputted fitting to or in synchronism with the video signal. The video processor portion 208 has a function for scaling the video signal inputted from the video decoder, or the video signal inputted from the HDMI receiver portion 201, into an arbitrary size, and also a function for converting it into R, G and B pixels. It is also able to conduct a process for superposing two (2) videos inputted from the HDMI receiver portion, or a process for displaying them aligning in parallel with.

The video output portion 209 is a display device, such as, a panel for displaying the video composed in the video processor portion 208, etc.

The audio output portion 212 is a speaker(s) or the like, for outputting the audio, which is processed in the audio processor portion 211. The controller portion 214 controls each portion of those from the tuner 200 to the storage portion 231 mentioned above.

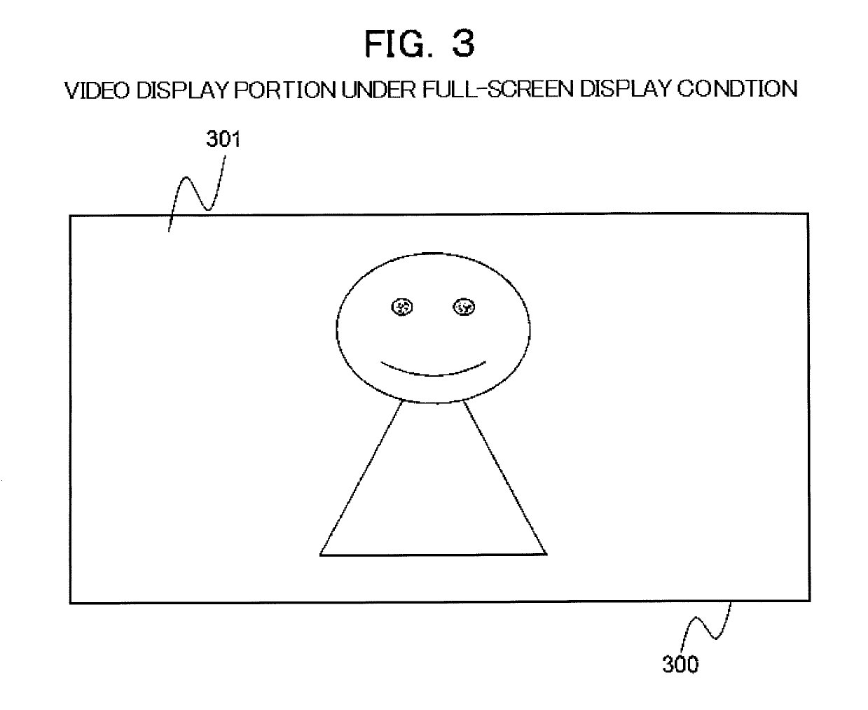

FIG. 3 shows an example of a video display, being displayed on the video output portion 209. A reference numeral 300 depicts the display device itself, 301 display information, which is displayed on the display devised, respectively. FIG. 3 is an example when one (1) piece of the video is displayed on a whole screen of the display device. In case where a video deceive is able to display the video of high definition, such as, 4 k×2 k, for example, such compression or subtractive process should not conducted, as far as possible, since it deteriorate the quality of picture.

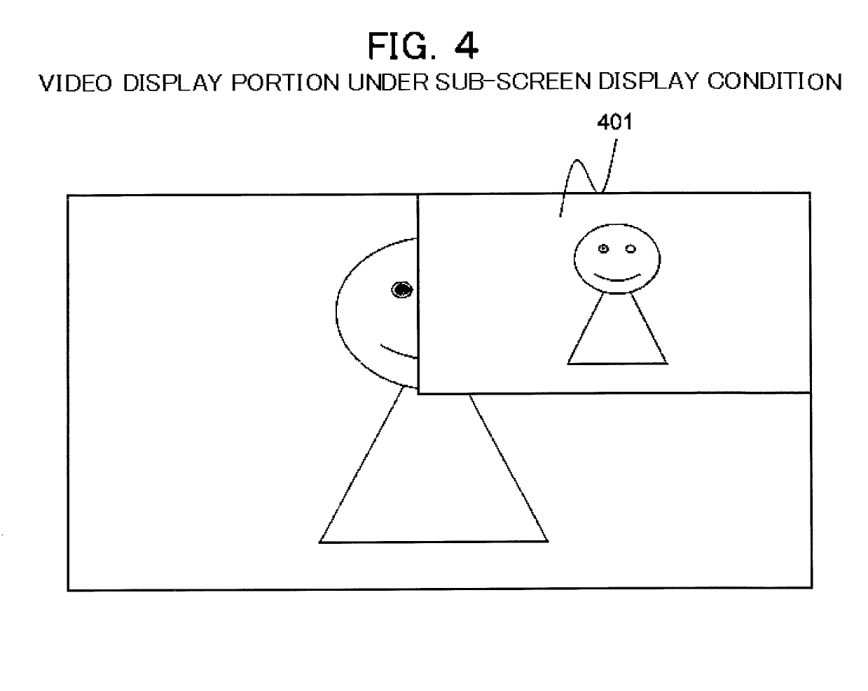

However, in case of a multi-channel transmission, etc., where a plural number of video signals are transmitted, there can be considered a use case of displaying such thumbnail pictures, as is shown by 400 in FIG. 4. In such cases, an amount or volume of transmission may be reduced by compression or thinning the pixel number thereof, depending on necessity thereof.

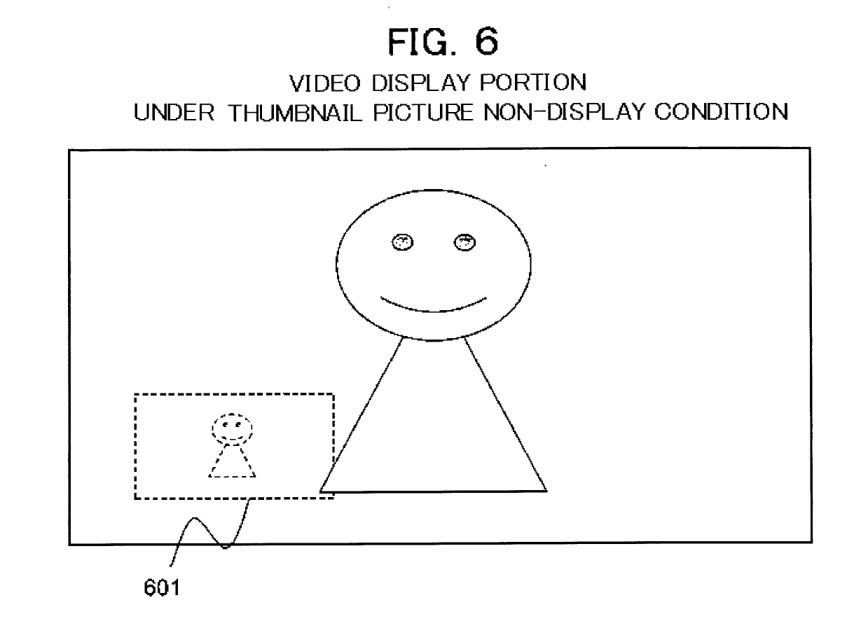

Also, as is shown by 601 in FIG. 6, although the plural numbers of the video signals are transmitted, but in case where a port of that plural number of the video signals is/are not displayed, it is possible to save a transmission band by stopping the transmission of the video signal(s) not displayed.

As a method for determining on if there is/are video signal (s) or not, which is/are not transmitted but not displayed, in the video transmitter apparatus 100, there can be considered one, for example, expanding to a multi-channel display condition in the E-EDID storing portion 202, as the display condition of the video output portion 209. With doing this, it is possible for the controller portion 114 of the video transmitter apparatus 100 to know the display condition of the video receiver apparatus as a destination of transmission, through the HDMI transmitter portion 113.

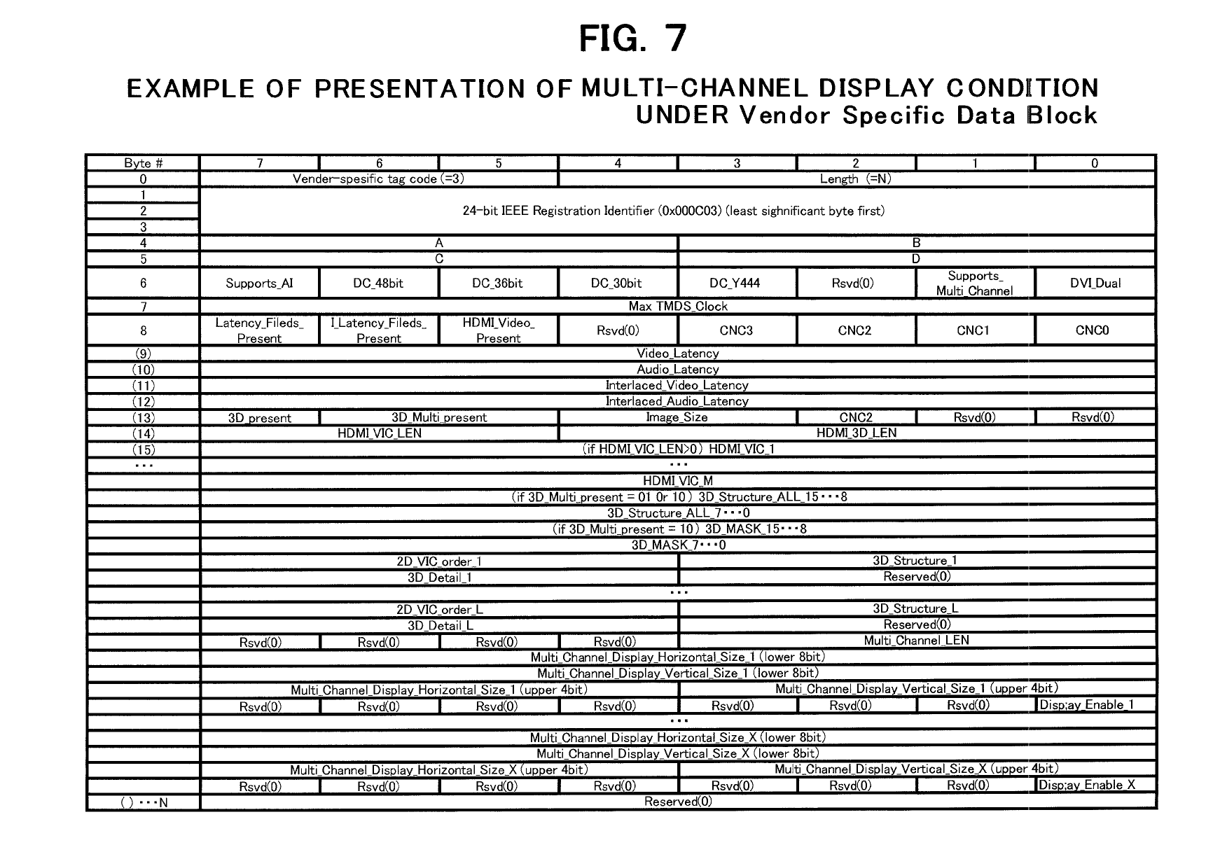

FIG. 7 is an example of expansion where E-EDID of the multi-channel information is expanded.

“Multi_Channel_LEN” is a size (Byte) of the multi-channel information, which follows thereafter. The following information has the following data, per one (1) channel.

“Multi_Channel_Display_Horizontal_Size_X (lower 8 bits)” is lower 8 Bits of a number of the horizontal pixels, which are now under the display condition thereof.

“Multi_Channel_Display_Size_X (lower 8 bit)” is lower 8 Bits of a number of the vertical pixels, which are now under the display condition thereof.

“Multi_Channel_Display_Horizontal_Size_X (upper 4 bit)” is upper 4 Bits of a number of the horizontal pixels, which are now under the display condition thereof.

“Multi_Channel_Display_Vertical_Size_X (upper 4 bit)” is upper 4 Bits of a number of the vertical pixels, which are now under the display condition thereof.

“Display_Enable_X” indicates if this channel is under the condition of display or not.

The controller portion 114, in case where the condition of video display of the channel on the air is shown by 301 in FIG. 3, for example, is able to transmit the video with limiting to such a compression method of a region that the picture quality can be restored completely, by compressing only a unit of line (for example, a RLE method or a ZIP method), being a reversible compression, in the compressor portion 112, while keeping YCbCr 4:4:4 since correlation of the pixels in the V direction.

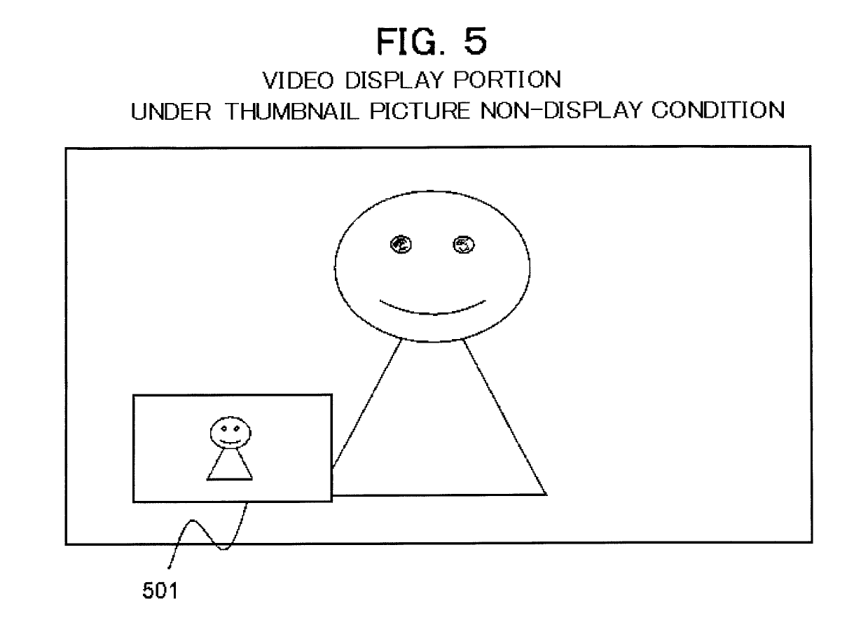

On the other hand, in case where the display size in the horizontal direction comes to be a half or less than the format of a transmission signal, as is shown by 501 in FIG. 5, it is possible to lower an amount of transmission by thinning the color difference signal down to YCbCr 4:2:2 in the video processor portion 111, other than the compression.

Further, as is shown by 501 in FIG. 5, on the thumbnail picture, being sufficiently small in both the horizontal/vertical directions, it is also possible to thin YCbCr down to 4:2:0 in the video processor portion 111, or compress by an irreversible compression method (for example, MPEG 2/H.264) with applying the transcoder 109, in case where an original video cannot be recognized.

And, since all the multi-channels are not always displayed, as is shown by 601 in FIG. 6, and there are cases where a part of the channels is not displayed, it is also possible to add a flag describing presence/absence of the display in the E-EDID, and thereby achieving such a control that the transmission itself is not conducted when it is not displayed.

In the explanation mentioned above, although explanation was made on an example by applying the E-EDID, as a means for determining the display condition of the video; however in the place of the E-EDID, it is also possible to transmit the display condition on the video receiver apparatus 200 to the video transmitter apparatus 100, while utilizing a two-way communication function, such as, a display condition communication by means of CEC and/or a display condition communication by means of the Ethernet I/Fs 105 and 205, etc. Or, the display condition on the video receiver apparatus 200 may be transmitted to the video transmitter apparatus 100 by a method other than that.

### Embodiment 2

In the embodiment 1, although the explanation was given of the example of controlling the change of necessity/unnecessary and the method for compressing the video signal to be transmitted from the video transmitter apparatus 100, upon basis of the display condition on the video receiver apparatus 200; however it may be also possible to control the change of the necessity/unnecessary and the method for compressing the video signal to be transmitted, upon basis of a specification (i.e., sizes, a resolution power, etc., of the display device).

For example, as a result of comparison between the resolution power of the video signal, which the video transmitter apparatus 100 transmits, and the resolution power of the video receiver apparatus 200, if the resolution power of the video receiver apparatus 200 is lower than the resolution power of the video signal to be transmitted, then the video transmitter apparatus 100 is able to compress the video signal to be transmitted fitting to the resolution power of the video receiver apparatus 200.

As a method for the video transmitter apparatus 100 to determine the resolution power of the video receiver apparatus 200 may be considered, for example, a method of applying the E-EDID therein, as was explained in the embodiment 1, or a method of applying the communication by means of CEC therein, or a method of applying the communication by means of the Ethernet I/Fs 105 and 205, or may be applied a method other than those.

### Embodiment 3

In the video transmitter apparatus 100, when a kind of the information to be transmitted cannot be determined, the necessity/unnecessary and the method of compression of the video signal to be transmitted may be controlled, upon basis of the kind of the information to be transmitted.

For example, if the information to be transmitted is data of text, it is compressed to be high in the compression ratio thereof even with the reversible compression, then it can be considered to select the reversible compression. Also, with a live broadcast and/or sports, since the picture can be considered to be rough, it can be considered to select a non-reversible compression. Also, with a movie, since it is the picture made up, it can be considered to select the reversible compression.

As a method for determining the kind of the information to be transmitted in the video transmitter apparatus, there can be considered one, i.e., referring to meta information added to the information to be transmitted, for example, but may be apply a method other than that.

### Embodiment 4

In an embodiment 4, explanation will be given on a method for controlling a compression process within the video transmitter apparatus 100, upon basis of an arrangement of plural numbers of video signals when they are arranged on plural numbers of layers.

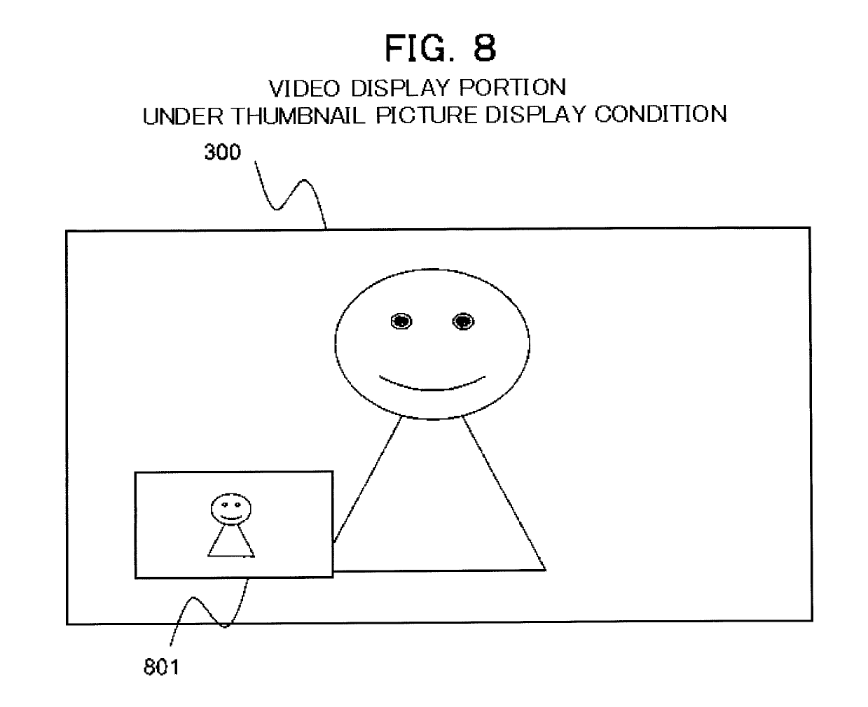

FIG. 8 shows an example of picture or video displayed on the video output portion 209, displaying a main picture and thumbnail pictures thereof, simultaneously. In FIG. 8 is shown a condition where the main picture and the thumbnail pictures are arranged on a layer in the front of that of the main picture.

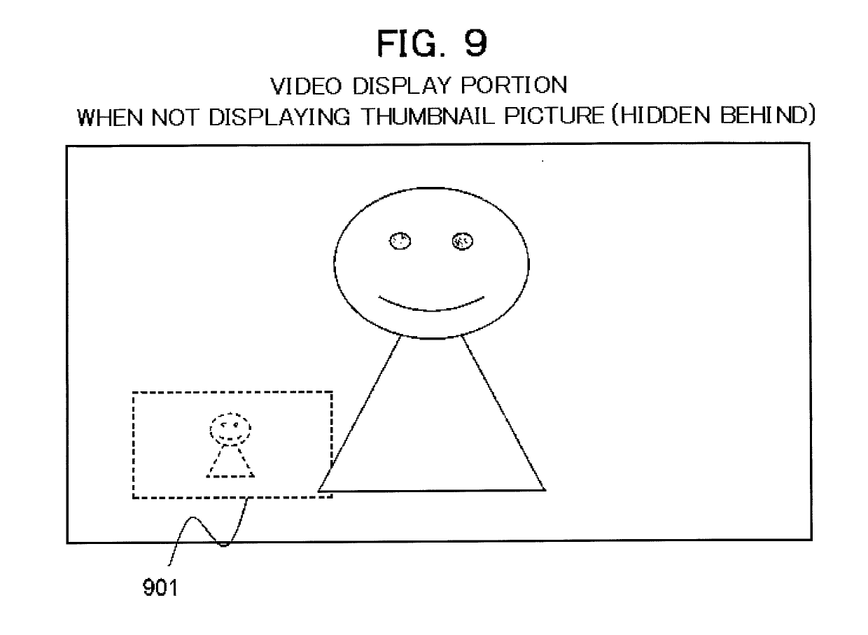

FIG. 9 shows a condition where the main picture is presented in front, while the thumbnail pictures are hidden behind that, after exchanging the display layers from the condition shown in FIG. 8.

Herein, explanation will be given on a method for transmitting the condition of the display layers for the plural numbers of video signals in the video receiver apparatus 200 to the video transmitter apparatus 100 with applying the E-EDID therein. By expanding the multi-channel display condition to the E-EDID storing portion 202 as the display condition of the video output portion 209, the controller portion 114 of the video transmitter apparatus 100 is able to know the display condition of the video receiver apparatus at the destination of transmission, through the HDMI receiver portion 201 and the HDMI transmitter portion 113.

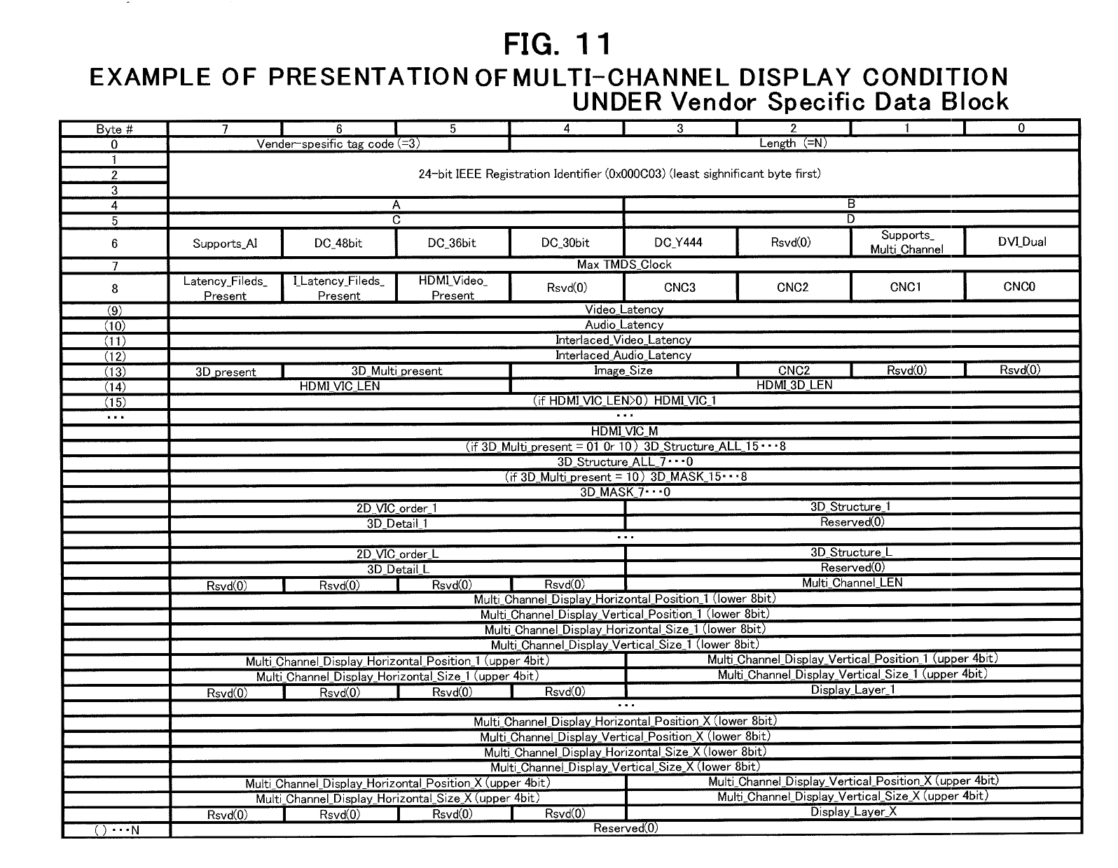

FIG. 11 shows an example of expansion when the E-EDID of the multi-channel information is expanded.

“Multi_Channel_LEN” is a size (Byte) of the multi-channel information, which follows thereafter. It has the following data, as the video position information, per one (1) channel.

“Multi_Channel_Display_Horizontal_Posdition_X (lower 8 bits)” is lower 8 Bits of a horizontal display starting position, which is now under the display condition thereof.

“Multi_Channel_Display_Posdition_X (lower 8 bits)” is lower 8 Bits of a vertical display starting position, which is now under the display condition thereof.

“Multi_Channel_Display_Horizontal_Size_X (lower 8 bits)” is lower 8 Bits of a number of the horizontal pixels, which are now under the display condition thereof.

“Multi_Channel_Display_Horizontal_Size_X (lower 8 bits)” is lower 8 Bits of a number of the vertical pixels, which are now under the display condition thereof.

“Multi_Channel_Display_Horizontal_Posdition_X (upper 4 bits)” is upper 8 Bits of the horizontal display starting position, which is now under the display condition thereof.

“Multi_Channel_Display_vertical_Posdition_X (upper 4 bits)” is upper 8 Bits of the vertical display starting position, which is now under the display condition thereof.

“Multi_Channel_Display_Horizontal_Size_X (upper 4 bits)” is upper 4 Bits of the horizontal pixels, which are now under the display condition thereof.

“Multi_Channel_Display_Vertical_Size_X (upper 4 bits)” is upper 4 Bits of the vertical pixels, which are now under the display condition thereof.

“Display_Layer_X” presents the display layer of this channel; i.e., when “0”, it indicates non-display, and when it is “1” or larger than that, it is indicated that the display is made in front much more as the numerical number thereof comes to be smaller.

The controller portion 114 of the video transmitter portion 100 can calculates the superposition of the videos from the “Display_Layer_X” or the video position information mentioned above, in case where the thumbnail picture(s) is/are hidden as is shown in FIG. 9, after changing the video display condition, from the condition where the thumbnail picture, as is shown by 801 in FIG. 8, to that where the thumbnail picture is hidden, as is shown in FIG. 9, and if the thumbnail picture is hidden completely, the controller portion 114 of the video transmitter portion 100 can controls the video processor portion 111, i.e., stopping the transmission, and thereby saving the band.

Also, even in case where the thumbnail picture is hidden, there can be considered such a situation that the video transmitter apparatus 100 continues to transmit the video signal of the thumbnail picture at a predetermined compression ratio, without stopping the transmission thereof. For example, when the display layer is exchanged so that the hidden thumbnail picture is displayed again, then it is necessary to transmit the video signal of the thumbnail picture on the side of the transmission, after rewriting the video position information on the video receiver apparatus 200; however, if the video transmitter apparatus 100 continues the transmission of the video signal of the thumbnail picture, even also when the thumbnail picture is hidden, at the compression ratio suitable for the display size of the thumbnail picture, which can be obtained from the video position information, it is possible to conduct the operation when the layer is exchanged at high speed, and to suppress an amount or volume of the transmission.

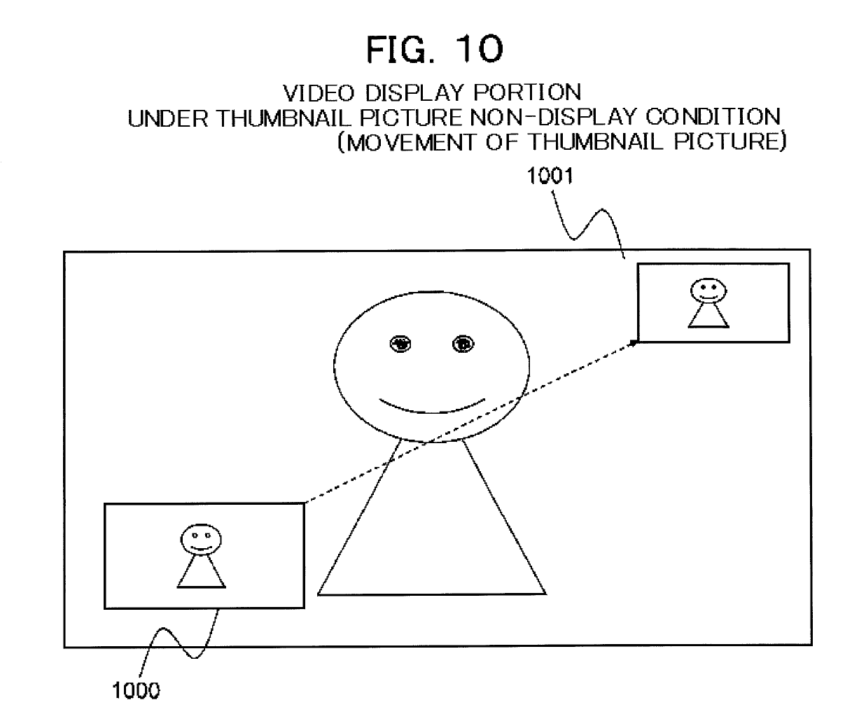

In similar, also when the thumbnail picture is transited from 1000 to 1001, as is shown by an example of display in FIG. 10, i.e., the position and/or the size of the thumbnail picture is/are changed, it is possible to make a control of exchanging the position and/or the size of the thumbnail picture at a higher speed, by continuing the transmission of the thumbnail picture on the video transmitter apparatus 100, in case where the thumbnail picture is in the condition of display, from the “Display_Layer_X” and the video position information mentioned above.

Also, from the “Display_Layer_X” and the video position information mentioned above, even if the thumbnail picture is in the condition of non-display, it is possible to make a control for satisfying both, restriction of the transmission band and convenience of exchange of display, by keeping transmission of the thumbnail picture, too, for a predetermined time-period “t” after transition of the condition, and stopping that transmission when the thumbnail picture is in the condition of non-display even after elapsing of the predetermined time-period “t”.

However, in the present embodiment, the explanation was given on the example, wherein the display layer of the video information on the video receiver apparatus 200 is transmitted to the video transmitter apparatus 100, with applying the E-EDID therein; however, the display layer of the video information on the video receiver apparatus 200 may be transmitted to the video transmitter apparatus 100, with applying another method than the above. For example, the display layer of the video information on the video receiver apparatus 200 may be transmitted to the video transmitter apparatus 100, with applying the two-way communication function, such as, the communication by means of the CEC or the communication by means of the Ethernet I/F 105 and 205, etc.

In this manner, with each of the embodiments explained in the above, it is possible to reduce the deterioration of the picture quality, which the user can feel, even in case of transmitting the plural numbers of video signals from the video transmitter apparatus to the video receiver apparatus. And, it is possible to transmit the plural numbers of channels, simultaneously, while reducing the deterioration of the picture quality that the user can feel, if conducting the transmission of a high-frequency band signal, such as, 4 k×2 k, for example, on the conventional physical layer corresponding to HDMI 1.4.

### EXPLANATION OF MARKS

100 video transmitter apparatus

101 tuner

102 Demux portion

103 audio decoder

104 video decoder

105 Ethernet I/F

106 memory

107 storage portion

108 Remux portion

109 transcoder

110 audio processor portion

111 video processor portion

112 compressor portion

113 HDMI transmitter portion

114 controller portion

115 HDMI transmission path

200 video receiver apparatus

201 HDMI receiver portion

202 E-EDID storing portion

203 tuner

204 Demux portion

205 Ethernet I/F

206 memory

207 video decoder

208 video processor portion

209 video output portion

210 audio decoder

211 audio processor portion

212 audio output portion

213 storage portion

214 controller portion

215 HDMI transmission path

300 video display portion under full-screen display condition

301 full-screen display condition

401 thumbnail picture display condition

501 thumbnail picture display condition

601 thumbnail picture display of non-display

800 video display portion under thumbnail picture display condition

801 thumbnail picture

901 thumbnail picture under non-display condition

1000 thumbnail picture

1001 thumbnail picture

1. A video transmitter apparatus for transmitting video information to a video receiver apparatus, wherein
transmission of the video information is controlled, upon basis of a condition of displaying the video information on said video receiver apparatus.

2. A video transmitter apparatus for transmitting video information to a video receiver apparatus, comprising:
a compressor portion, which is configured to compress the video signal; and
a transmitter portion, which is configured to transmit the video information compressed in said compressor portion, wherein
said compressor portion and said transmitter portion are controlled, upon basis of a condition of displaying the video information on said video receiver apparatus.

3. The video transmitter apparatus of the claim 2, wherein
said transmitter apparatus transmits plural numbers of the video information, and
said compressor portion and said transmitter portion are controlled, upon basis of each of conditions of displaying said plural numbers of the video information on said video receiver apparatus.

4. The video transmitter apparatus of the claim 2, wherein
the video information not being displayed on said video receiver apparatus is not transmitted from said transmitter portion.

5. The video transmitter apparatus of the claim 3, wherein
said compressor portion and said transmitter portion are controlled, upon basis of display layers of the plural numbers of video information, which are transmitted from said transmitter portion, on said video receiver apparatus.

6. The video transmitter apparatus of the claim 5, wherein
transmission is stopped of the video information, being disposed at a back surface of other information on said video receiver apparatus, thereby not being displayed on said video receiver apparatus, among the plural numbers of video information, which are transmitted from said transmitter portion.

7. The video transmitter apparatus of the claim 2, further comprising:
a readout portion, which is configured to read out information relating to said video receiver apparatus, which said video receiver apparatus has, wherein
the display condition of said video receiver apparatus is determined, upon basis of the information relating to said video receiver apparatus, which is read out by said readout portion.

8. The video transmitter apparatus of the claim 2, further comprising:
a communicator portion, which is configured to conduct two-way communication between said video receiver apparatus, wherein
the display condition of said video receiver apparatus is determined, upon basis of the communication between said video receiver apparatus through said communicator portion.

9. A video receiver apparatus for receiving video information, which is transmitted from a video transmitter apparatus, wherein
a display condition of the video information, which is transmitted from said video transmitter apparatus, is transmitted to said video transmitter apparatus.

10. A video receiver apparatus for receiving video information, which is transmitted from a video transmitter apparatus, comprising:
a receiver portion, which is configured to receive the video signal;
a processor portion, which is configured to process the video information, which is received by said receiver portion; and
a display portion, which is configured to display the video information, which is processed in said processor portion, wherein
a display condition of the video information on said display portion is transmitted to said video transmitter apparatus.

11. The video receiver apparatus of the claim 10, wherein
said receiver portion receives plural numbers of the video information,
said display portion displays the plural numbers of the video information thereon, and
the display conditions of the plural numbers of video information on said display portion are transmitted to said video transmitter portion.

12. The video receiver apparatus of the claim 10, further comprising:
a memory portion, which is configured to hold information relating to said video receiver apparatus, wherein
the information relating to said video receiver apparatus, which is held in said memory portion includes information indicating the display condition of the video information on said display portion.

13. The video receiver apparatus of the claim 10, further comprising:
a communicator portion, which is configured to conduct two-way communication between said video transmitter apparatus, wherein
the display condition on said display portion is transmitted to said video transmitter apparatus, through communication between said transmitter apparatus through said communicator portion.

14. The video receiver apparatus of the claim 11, wherein
said display portion displays the plural numbers of the video information, dividing into plural numbers of layers, and
the layers for displaying the plural numbers of video information on said display portion are transmitted to said video transmitter apparatus.

15. The video receiver apparatus of the claim 14, further comprising:
a memory portion, which is configured to hold information relating to said video receiver apparatus, wherein
the information relating to said video receiver apparatus, which is held in said memory portion, includes information indicating display layers of the plural numbers of video information on said display portion.

16. The video receiver apparatus of the claim 14, further comprising:
a communicator portion, which is configured to conduct two-way communication between said video transmitter apparatus, wherein
the display layers of the plural numbers of video information on said display portion are transmitted to said video transmitter apparatus, by means of the communication between said transmitter apparatus through said communicator portion.

17. A video transmitting method for transmitting video information from a video transmitter apparatus to a video receiver apparatus, wherein
transmission of the video information is controlled, upon basis of a display condition of the video information on said video receiver apparatus.

18. A video transmitting method for transmitting video information from a video transmitter apparatus to a video receiver apparatus, comprising the following steps of:
a step for compressing the video information; and
a step for transmitting the video information compressed, wherein
compression of the video information and transmission of the video information are controlled, upon basis of a display condition of the video information on said video receiver apparatus.

19. A video receiving method for receiving video information transmitted from a video transmitter apparatus upon a video receiver apparatus, wherein
a display condition of the video information, which is transmitted from said video transmitter apparatus, on said video receiver apparatus is transmitted to said video transmitter apparatus.

20. A video receiving method for receiving video information transmitted from a video transmitter apparatus upon a video receiver apparatus, comprising the following steps of:
a step for receiving the video information;
a step for processing the video information received on a receiver potion; and
a step for displaying the video information processed in a processor portion, wherein
a display condition of the video information on a display of said video information is transmitted to said video transmitter apparatus.
